(19) United States
(12) Patent Application Publication
(10) Pub. No.: US 2026/0024793 A1
(43) Pub. Date: Jan. 22, 2026

(54) MEMBRANE ELECTRODE ASSEMBLY

(71) Applicant: TOYOTA JIDOSHA KABUSHIKI KAISHA, Toyota-shi (JP)

(72) Inventors: Shunsuke TAKAHASHI, Susono-shi (JP); Keiichi OKUBO, Susono-shi (JP)

(73) Assignee: TOYOTA JIDOSHA KABUSHIKI KAISHA, Toyota-shi (JP)

(21) Appl. No.: 19/271,740

(22) Filed: Jul. 16, 2025

(30) Foreign Application Priority Data
Jul. 18, 2024 (JP) 2024-114480

(51) Int. Cl. H01M 8/1004; H01M 4/86; H01M 4/92; H01M 8/10

(52) U.S. Cl. CPC H01M 8/1004; H01M 4/8663; H01M 4/926; H01M 2008/1095

(57) ABSTRACT

The present disclosure provides a membrane electrode assembly having excellent durability and performance. In the embodiment, the membrane electrode assembly includes metal ions selected from cerium ions and manganese ions, and a crown ether compound capable of forming an inclusion compound with the metal ions or a salt thereof. The cathode catalyst layer includes an electrode catalyst and an electrolyte. The electrode catalyst is a metal-supported carrier in which metal particles having catalytic activity are supported on a carrier having pores. An external-internal surface area ratio is 1.20 or less. An external-internal particle count ratio is 0.70 or less.

### CROSS REFERENCE TO RELATED APPLICATIONS

The present application claims priority from Japanese patent application JP 2024-114480 filed on Jul. 18, 2024, the entire content of which is hereby incorporated by reference into this application.

### BACKGROUND

### Technical Field

The present disclosure relates to a membrane electrode assembly.

### Background Art

A solid polymer fuel cell generally includes a membrane electrode assembly (also referred to as “MEA”). The membrane electrode assembly includes a solid polymer electrolyte membrane as an electrolyte membrane, an anode catalyst layer disposed on one surface of the solid polymer electrolyte membrane, and a cathode catalyst layer disposed on the other surface of the solid polymer electrolyte membrane. The anode catalyst layer functions as a fuel electrode, and the cathode catalyst layer functions as an air electrode. Gas diffusion layers are further disposed to both surfaces of the MEA in some cases, and this configuration is referred to as a membrane electrode gas diffusion layer assembly (also referred to as “MEGA”). Here, in the solid polymer fuel cell, during power generation, hydrogen peroxide (H₂O₂) is generated from water and oxygen, and hydroxyl radicals (·OH) are generated from the hydrogen peroxide in the catalyst layer in some cases. The hydrogen peroxide and the hydroxyl radicals cause deterioration of electrolyte resins, such as ionomer, included in the solid polymer electrolyte membrane and the catalyst layers.

Therefore, there has been proposed a technique to detoxify the hydrogen peroxide radicals generated during power generation of a fuel cell by containing a radical quenching agent, such as cerium ions, in an MEA. Detoxification of hydrogen peroxide radicals is, for example, a reaction from the hydrogen peroxide radicals to water.

For example, in “Enhancement of oxidative stability of PEM fuel cell by introduction of HO radical scavenger in Nafion ionomer” by Vo Dinh Cong Tinh et al. (Journal of Membrane Science 613 (2020) 118517), a membrane electrode assembly (MEA) in which a coordinated complex of 18-crown-6 ether/cerium ions (CRE/Ce) is embedded in Nafion ionomer between a catalyst and membrane layers is disclosed. It is disclosed that, while Ce plays a role in trapping HO-radicals, CRE alleviates dissolution of cerium ions from the MEA during cell operation (for example, Abstract).

### SUMMARY

As described above, in “Enhancement of oxidative stability of PEM fuel cell by introduction of HO radical scavenger in Nafion ionomer” by Vo Dinh Cong Tinh et al. (Journal of Membrane Science 613 (2020) 118517), an anode catalyst layer containing cerium ions as a radical quenching agent and 18-crown-6-ether is disclosed. One problem of cerium ions is a decrease in durability in association with a decrease in concentration due to movement of ions. However, in “Enhancement of oxidative stability of PEM fuel cell by introduction of HO radical scavenger in Nafion ionomer” by Vo Dinh Cong Tinh et al. (Journal of Membrane Science 613 (2020) 118517), it is described that adding 18-crown-6-ether can alleviate the dissolution of cerium ions to the outside of an MEA. However, when a large amount of a crown ether compound, such as 18-crown-6-ether, is added to a membrane electrode assembly, a decrease in IV performance under high temperature and low humidification conditions becomes a problem. Therefore, it proved that there is room for improvement in terms of the performance of the membrane electrode assembly containing a radical quenching agent, such as cerium ions, and a crown ether compound, such as 18-crown-6-ether.

Therefore, the present disclosure provides a membrane electrode assembly having excellent durability and performance.

The inventors have intensively studied to solve the above-described problem and found that the reason for the decrease in performance described above is that a crown ether compound contained in the anode catalyst layer and the electrolyte membrane migrates to the cathode catalyst layer, therefore poisoning the cathode catalyst or decreasing proton conductivity in the ionomer of the cathode. The inventors have further advanced the study and discovered that using a predetermined metal-supported carrier as an electrode catalyst in a cathode catalyst layer allows suppressing catalyst poisoning by a crown ether compound, and as a result, a membrane electrode assembly having excellent durability can be provided, thus achieving the present disclosure.

Exemplary aspects of the embodiment are as follows.
(1) A membrane electrode assembly comprises a solid polymer electrolyte membrane, an anode catalyst layer, and a cathode catalyst layer. The anode catalyst layer is disposed on one surface of the solid polymer electrolyte membrane. The cathode catalyst layer is disposed on the other surface of the solid polymer electrolyte membrane. The membrane electrode assembly comprises metal ions selected from cerium ions and manganese ions, and a crown ether compound capable of forming an inclusion compound with the metal ions or a salt thereof. The cathode catalyst layer comprises an electrode catalyst and an electrolyte. The electrode catalyst is a metal-supported carrier in which metal particles having catalytic activity are supported on a carrier having pores. When metal particles present on outermost surfaces of primary particles of the carrier are external particles, and metal particles present inside the outermost surfaces of the primary particles of the carrier are internal particles, a ratio of a total surface area of the external particles to a total surface area of the internal particles (total surface area of external particles/total surface area of internal particles) is 1.20 or less, and a ratio of a total particle count of the external particles to a total particle count of the internal particles (total particle count of external particles/total particle count of internal particles) is 0.70 or less.
(2) The membrane electrode assembly according to (1), in which a number of ring members of a ring structure of the crown ether compound is 15 or more.
(3) The membrane electrode assembly according to (1) or (2), in which the crown ether compound has a molecular weight of 300 or more.
(4) The membrane electrode assembly according to any one of (1) to (3), in which the crown ether compound is at least one compound selected from the group consisting of dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, and dicyclohexano-24-crown-8-ether, and compounds in which an aromatic ring or an aliphatic ring of these compounds is substituted by at least one substituent selected from a halogen atom, a hydroxy group, an amino group, a nitro group, a formyl group, an alkyl group having 1 to 6 carbon atoms, a hydroxyalkyl group having 1 to 6 carbon atoms, a carboxyalkyl group having 2 to 7 carbon atoms, and an aryl group having 6 to 14 carbon atoms.
(5) The membrane electrode assembly according to any one of (1) to (4), in which for the metal particles, at least one kind is selected from the group consisting of platinum particles, platinum alloy particles, and composite particles containing platinum.

The present disclosure allows providing the membrane electrode assembly having excellent durability.

### BRIEF DESCRIPTION OF THE DRAWINGS

FIG. 1 is a schematic cross-sectional view for describing an exemplary configuration of a membrane electrode assembly and a solid polymer fuel cell according to the embodiment and is a cross-sectional view of a main part of an exemplary fuel cell 10.

### DETAILED DESCRIPTION

The embodiment is a membrane electrode assembly that comprises: a solid polymer electrolyte membrane; an anode catalyst layer disposed on one surface of the solid polymer electrolyte membrane; and a cathode catalyst layer disposed on the other surface of the solid polymer electrolyte membrane, wherein the membrane electrode assembly comprises metal ions selected from cerium ions and manganese ions, and a crown ether compound capable of forming an inclusion compound with the metal ions or a salt thereof, wherein the cathode catalyst layer comprises an electrode catalyst and an electrolyte, wherein the electrode catalyst is a metal-supported carrier in which metal particles having catalytic activity are supported on a carrier having pores, and wherein when metal particles present on outermost surfaces of primary particles of the carrier are external particles, and metal particles present inside the outermost surfaces of the primary particles of the carrier are internal particles, a ratio of a total surface area of the external particles to a total surface area of the internal particles (total surface area of external particles/total surface area of internal particles) is 1.20 or less, and a ratio of a total particle count of the external particles to a total particle count of the internal particles (total particle count of external particles/total particle count of internal particles) is 0.70 or less.

The embodiment allows providing the membrane electrode assembly having excellent durability. In the embodiment, cerium ions and/or manganese ions that function as a radical quenching agent are added in the membrane electrode assembly (such as the anode catalyst layer or the solid polymer electrolyte membrane). Since hydrogen peroxide radicals can be trapped and detoxified by cerium ions and/or manganese ions, deterioration of the membrane electrode assembly can be suppressed. Additionally, by adding a host compound for the above-described metal ions in the membrane electrode assembly, movement of the above-described metal ions can be suppressed, reducing concentration bias in a planar direction. At that time, by using the crown ether compound or a salt thereof as the host compound, the effect of suppressing the movement of the metal ions can be further improved. Furthermore, in the membrane electrode assembly according to the embodiment, by using the above-described predetermined metal-supported carrier as the electrode catalyst in the cathode catalyst layer, poisoning of the cathode catalyst by the crown ether compound can be suppressed, thus suppressing a decrease in performance under high loads. For the reasons described above, the embodiment allows providing the membrane electrode assembly having excellent durability and performance.

The following describes a configuration of the embodiment.

A solid polymer electrolyte membrane has a function to block distribution of electrons and gases and to move protons (H⁺) generated in an anode from an anode side catalyst layer to a cathode side catalyst layer. As the solid polymer electrolyte membrane in the embodiment, an electrolyte membrane having proton conductivity known in the technical field can be used. As the solid polymer electrolyte membrane, for example, a membrane formed of a fluororesin having sulfonate groups as an electrolyte (such as Nafion (produced by DuPont), FLEMION (produced by AGC Inc.), and Aciplex (produced by Asahi Kasei Corporation)) can be used.

While the thickness of the solid polymer electrolyte membrane is not particularly limited, it is, for example, 5 μm to 50 μm from the aspect of improvement in proton conductivity.

The cathode catalyst layer functions as an air electrode (oxygen electrode). The cathode catalyst layer includes at least an electrode catalyst and an electrolyte. In the embodiment, as the electrode catalyst in the cathode catalyst layer, a metal-supported carrier, in which metal particles having catalytic activity are supported on a carrier having pores, is used. In a metal-supported catalyst, particulate catalyst metal is supported on a carrier. In the present disclosure, the state where the catalyst is supported on the carrier having pores is a concept including at least one of a state where the catalyst is supported on the carrier surface or a state where the catalyst is supported on inner wall surfaces inside the pores of the carrier.

As a method for supporting metal particles on a carrier, a method that has been conventionally used can be employed. Examples of the method include, for example, a method in which a carrier dispersion liquid where carriers are dispersed is mixed with metal particles having catalytic activity, filtered, washed, re-dispersed into ethanol or the like, and then dried with a vacuum pump or the like. After drying, heat treatment may be performed as necessary.

In the embodiment, a carrier having pores is used as the carrier.

In the embodiment, the electrode catalyst in the cathode catalyst layer is a metal-supported carrier in which metal particles having catalytic activity are supported on a carrier having pores. When metal particles present on the outermost surfaces of primary particles of the carrier are external particles, and metal particles present inside the outermost surfaces of the primary particles of the carrier are internal particles, the electrode catalyst satisfies the following requirements (1) and (2).
(1) The ratio of the total surface area of the external particles to the total surface area of the internal particles (total surface area of external particles/total surface area of internal particles) (also referred to as an external-internal surface area ratio) is 1.20 or less.
(2) The ratio of the total particle count of the external particles to the total particle count of the internal particles (total particle count of external particles/total particle count of internal particles) (also referred to as an external-internal particle count ratio) is 0.70 or less.

Examples of a method for measuring positions where the metal particles supported on the carrier are present include an observation method using an electron microscope. By gradually changing the observation angle of an electrode catalyst to be measured, taking a plurality of images, and reconstructing them, an object can be photographed three-dimensionally. The barycentric coordinates of the metal particles are determined three-dimensionally, and the metal particles positioned on the outermost surfaces of the primary particles of the carrier are judged as the external particles, and the metal particles positioned inside the outermost surfaces are judged as the internal particles. When particles to be evaluated are selected, the following procedure may be satisfied so that no variation appears.

The count of particles to be evaluated is, for example, 100 or more, is 200 or more in some embodiments, and may be 1000 or more. In some embodiments, the particles to be evaluated are selected from at least two (five or more in some embodiments) visual fields, and they are selected so that the count of particles selected from each visual field is equal in each visual field.

In the electrode catalyst in the cathode catalyst layer of the embodiment, the ratio of the total surface area of the external particles to the total surface area of the internal particles (total surface area of external particles/total surface area of internal particles) is 1.20 or less, as described above. It is effective to support platinum inside the carrier as a countermeasure against the problem of crown ethers that have migrated in small amounts from the anode catalyst layer to the cathode catalyst layer poisoning the cathode catalyst and decreasing power generation performance. When the external-internal surface area ratio is 1.20 or less, catalyst poisoning by crown ethers is less likely to occur. Therefore, the external-internal surface area ratio of 1.20 or less may be used.

The external-internal surface area ratio is 0.30 or more in some embodiments, 0.40 or more in some embodiments, 0.50 or more in some embodiments, 0.60 or more in some embodiments, 0.70 or more in some embodiments, 0.80 or more in some embodiments, 0.90 or more in some embodiments, 1.00 or more in some embodiments, and 1.10 or more in some embodiments. The external-internal surface area ratio is 1.18 or less in some embodiments, and 1.16 or less in some embodiments.

In the electrode catalyst in the cathode catalyst layer of the embodiment, the ratio of the total particle count of the external particles to the total particle count of the internal particles (total particle count of external particles/total particle count of internal particles) is 0.70 or less, as described above. It is effective to support platinum inside the carrier as a countermeasure against the problem of crown ethers that have migrated in small amounts from the anode catalyst layer to the cathode catalyst layer poisoning the cathode catalyst and decreasing power generation performance. When the external-internal particle count ratio is 0.70 or less, catalyst poisoning by crown ethers is less likely to occur. Therefore, the external-internal particle count ratio of 0.70 or less may be used.

The external-internal particle count ratio is 0.35 or more in some embodiments, 0.40 or more in some embodiments, 0.45 or more in some embodiments, 0.50 or more in some embodiments, 0.55 or more in some embodiments, and 0.60 or more in some embodiments. The external-internal particle count ratio is 0.69 or less in some embodiments, and 0.68 or less in some embodiments.

The total particle count of the internal particles and the total particle count of the external particles can be calculated using the above-described observation method using an electron microscope or other methods.

The method for evaluating the total surface area of particles is as follows. A particle diameter (r) of a measured particle is defined as a maximum diameter. The surface area is calculated for each measured particle, and the total surface area is obtained by adding up all the surface areas. A spherical model is used for calculating the surface area(S), where S=2π(r/2)². The surface area calculated for each particle is aggregated individually for the external particles and the internal particles into the total surface area of the external particles and the total surface area of the internal particles, respectively.

While the carrier is not particularly limited, examples of the carrier include, for example, carbon, oxide, or the like. The carbon may be carbon having electron conductivity. For the carrier, one kind may be used alone, or two or more kinds may be used in combination.

Examples of a carbon carrier include, for example, carbon black (such as acetylene black, Ketjen black, or furnace black), activated carbon, graphite, glassy carbon, graphene, carbon fiber, carbon nanotube, carbon nitride, sulfurized carbon, or carbon phosphide. For the carbon carrier, one kind may be used alone, or two or more kinds may be used in combination.

Examples of an oxide carrier include, for example, titanium oxide, niobium oxide, tin oxide, tungsten oxide, or molybdenum oxide. For the oxide carrier, one kind may be used alone, or two or more kinds may be used in combination.

The catalyst metal is not particularly limited as long as it exhibits a catalytic action in a reaction at the electrodes.

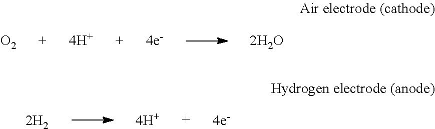

It is only necessary for the metal particles to be metal having oxygen reduction catalytic ability. Examples of the metal include platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and two or more kinds of these metals may be used. For the metal particles, at least one kind is selected from the group consisting of platinum particles, platinum alloy particles, and composite particles containing platinum in some embodiments. Examples of metals other than platinum contained in the platinum alloy and the composite particles containing platinum include, for example, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. One kind of the metals may be used alone, or two or more kinds may be used in combination.

While the average particle diameter of the metal particles is not particularly limited, it is 1 nm to 10 nm in some embodiments. The particle diameter is calculated as a sphere-equivalent diameter from the volume of a particle in a transmission electron microscope photograph. For the average particle diameter, the particle diameters (sphere-equivalent diameters) of 100 to 1000 particles are measured with a transmission electron microscope, and their average value may be the average particle diameter of the metal particles.

As long as the carrier includes primary particles having pores, it may also include secondary particles formed by the aggregation of the primary particles having pores. In the embodiment, a hole perforated in a primary particle, whose diameter satisfies 1 nm to 300 nm and whose depth from the outermost surface of the primary particle is 1 nm or more, is defined as a pore. A primary particle is a minimum unit of a particle of a carrier that cannot be decomposed.

The average particle diameter of the primary particles of the carrier may be, for example, 5 nm to 3000 nm. The average particle diameter of the primary particles of the carrier is 50 nm to 2000 nm in some embodiments, and 100 nm to 1500 nm in some embodiments. The particle diameter is calculated as a sphere-equivalent diameter from the volume of a particle in a transmission electron microscope photograph. For the average particle diameter, the particle diameters (sphere-equivalent diameters) of 100 to 1000 carrier particles are measured with a transmission electron microscope, and their average value may be the average particle diameter of the carrier particles.

While the metal supported rate of the metal particles supported on the carrier is not particularly limited, it is, for example, 1 mass % to 50 mass %, and 29 mass % to 48 mass % in some embodiments.

While the content of the electrode catalyst in the cathode catalyst layer is not particularly limited, for example, the content is 3 mass % to 40 mass % of the total mass of the catalyst layer.

The electrolyte used for the cathode catalyst layer is an ionomer having a sulfonate group in some embodiments. The ionomer is also referred to as cation-exchange resin, and is present as a cluster formed of ionomer molecules. The ionomer is not particularly limited, and, for example, the ionomer known in the technical field can be used. Examples of the ionomer include: fluororesin-based electrolyte, such as perfluorosulfonic acid resin; sulfonated plastic-based electrolyte, such as sulfonated polyether ketone, sulfonated polyethersulfone, sulfonated polyether ether sulfone, sulfonated polysulfone, sulfonated polysulfide, and sulfonated polyphenylene; and sulfoalkylated plastic-based electrolyte, such as sulfoalkylated polyether ether ketone, sulfoalkylated polyethersulfone, sulfoalkylated polyetherethersulfone, sulfoalkylated polysulfone, sulfoalkylated polysulfide, and sulfoalkylated polyphenylene. One electrolyte may be used alone, or two or more electrolytes may be used in combination.

The anode catalyst layer functions as a fuel electrode, that is, a hydrogen electrode.

The anode catalyst layer includes an electrode catalyst and an electrolyte, such as an ionomer. The ionomer is an ionomer having a sulfonate group in some embodiments. Examples of the ionomer having a sulfonate group include those described above. In one embodiment, the anode catalyst layer can contain, in addition to the electrode catalyst and the ionomer, metal ions selected from cerium ions and manganese ions, and a crown ether compound capable of forming an inclusion compound with the metal ions.

While the electrode catalyst is not particularly limited, for example, the above-described materials can be used.

While the ionomer having a sulfonate group is not particularly limited, examples thereof include a polymer electrolyte resin having ionic conductivity, such as a perfluorosulfonic acid ionomer. Specific examples of the ionomer having a sulfonate group include Nafion and Aquivion (Solvay S.A.).

The membrane electrode assembly according to the embodiment includes metal ions selected from cerium ions and manganese ions, and a crown ether compound capable of forming an inclusion compound with the metal ions or a salt thereof (a host compound). Since cerium ions and/or manganese ions function as a radical quenching agent and can trap and detoxify hydrogen peroxide radicals, deterioration of the membrane electrode assembly can be suppressed. Additionally, by adding the crown ether compound, which is a host compound for the above-described metal ions, in the membrane electrode assembly, movement of the above-described metal ions can be suppressed, reducing concentration bias in the planar direction.

The metal ions are selected from cerium ions and manganese ions. The cerium ions and the manganese ions function as a radical quenching agent. The radical quenching agent can facilitate conversion of hydroxyl radicals generated from hydrogen peroxide into hydroxide ions, suppressing deterioration of the anode catalyst layer. For example, the reaction of the hydroxyl radicals to the hydroxide ions by the cerium ions is as follows.

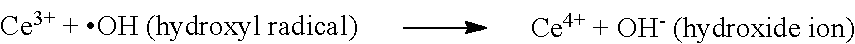

The cerium ions may be positive trivalent ions or may be positive quadrivalent ions. The manganese ions may be positive trivalent ions or may be positive quadrivalent ions.

While a cerium salt for obtaining the cerium ions is not particularly limited, examples of the cerium salt include cerium nitrate, cerium carbonate, cerium acetate, cerium chloride, ceric sulfate, diammonium cerium nitrate, or tetraammonium cerium sulfate. For the cerium salt, one kind may be used alone, or two or more kinds may be used in combination. The cerium salt may be an organometallic complex salt. Examples of the organometallic complex salt include, for example, cerium acetylacetonate.

While a manganese salt for obtaining the manganese ions is not particularly limited, examples of the manganese salt include manganese nitrate, manganese carbonate, manganese acetate, manganese chloride, or manganese sulfate. For the manganese salt, one kind may be used alone, or two or more kinds may be used in combination.

The crown ether compound or the salt thereof as a host compound in the embodiment forms an inclusion compound with the cerium ions or the manganese ions as a guest compound. The inclusion compound means an addition compound having a configuration in which the above-described metal ions as a guest compound are included in the host compound. For the crown ether compound, one kind may be used alone, or two or more kinds may be used in combination.

The crown ether compound has a cyclic structure, and the number of ring members of the cyclic structure is 15 or more in some embodiments, and 18 or more in some embodiments. The crown ether compound is a compound having a ring including a repeating structure of (—CH₂—CH₂—Y—) units or (—CH₂—CH₂—CH₂—Y—) units, where Y is at least one hetero atom selected from O, S, N, and P. The crown ether compound traps the metal ions in the cyclic structure to form an inclusion compound. The number of ring members of the crown ether compound is 15 or more in some embodiments, and 18 or more in some embodiments.

In the embodiment, the crown ether compound is a compound having a molecular weight of 300 or more in some embodiments. By using the crown ether compound having a molecular weight of 300 or more, a migration suppression effect can be obtained, that is, the migration of the crown ether compound from the anode catalyst layer or the electrolyte membrane to the cathode catalyst layer can be suppressed.

Examples of the crown ether compound include, for example, crown ether or a crown ether derivative. Examples of the crown ether having a molecular weight of 300 or more include, for example, 21-crown-7-ether and 24-crown-8-ether. In the embodiment, the crown ether compound is a crown ether compound having an aromatic ring or aliphatic ring in some embodiments. The crown ether compound having an aromatic ring or aliphatic ring has high hydrophobicity due to its structure and, therefore, is excellent in the migration suppression effect. Examples of the crown ether compound having an aromatic ring or aliphatic ring include, for example, dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, or dicyclohexano-24-crown-8-ether, and compounds in which an aromatic ring or an aliphatic ring of these compounds is substituted by at least one substituent selected from a halogen atom (such as a fluorine atom or a bromine atom), a hydroxy group, an amino group, a nitro group, a formyl group, an alkyl group having 1 to 6 carbon atoms (for example, a methyl group, an ethyl group, a propyl group, and a butyl group), a hydroxyalkyl group having 1 to 6 carbon atoms, a carboxyalkyl group having 2 to 7 carbon atoms, and an aryl group having 6 to 14 carbon atoms (for example, a phenyl group). The number of substituents is, for example, from 1 to 6, from 1 to 5, from 1 to 4, from 1 to 3, 1 or 2, or 1. One of the compounds may be used alone, or two or more of the compounds may be used in combination.

In the anode catalyst layer in the membrane electrode assembly of the embodiment, at least part of the crown ether compound and the metal ions form an inclusion compound.

Examples of the salt of the crown ether compound include, for example, nitrate, sulfate, carbonate, acetate, or propionate. For the salt, one kind may be used alone, or two or more kinds may be used in combination.

The crown ether compound and the metal ions can be contained in the anode catalyst layer, the solid polymer electrolyte membrane, or both of them.

When the anode catalyst layer contains the crown ether compound and the metal ions, the anode catalyst layer contains at least an electrode catalyst, an electrolyte, metal ions selected from cerium ions and manganese ions, and a crown ether compound with metal ions. The above-described metal ions can facilitate conversion of hydroxyl radicals generated from hydrogen peroxide into hydroxide ions, suppressing deterioration of the anode catalyst layer.

In some embodiments, the content of the above-described metal ions and the crown ether compound in the anode catalyst layer is 0.1 mass % to 20 mass % of the total amount of the solid content of the anode catalyst layer. Regarding the content, the inclusion compound is regarded as a mixture of the metal ions and the crown ether compound. That is, when the above-described metal ions and the crown ether compound are added in the anode catalyst layer separately or simply in a mixed manner, only the total amount of the compound metal ions and crown ether compound is subject to calculation, without considering the amount of an inclusion compound generated in the polymer electrolyte even when it is generated. Additionally, when an inclusion compound is formed in advance, and then the inclusion compound is added in the anode catalyst layer, the amount of the inclusion compound is the total amount of the metal ions and the crown ether compound forming the inclusion compound. Furthermore, when metal ions and a crown ether compound, which do not form an inclusion compound, further exist other than the metal ions and the crown ether compound that form an inclusion compound, they are also subject to calculation.

For the relative ratio of the crown ether compound to the above-described metal ions in the embodiment, the mole ratio of the crown ether compound to the above-described metal ions ([number of moles of crown ether compound]/[number of moles of metal ions]) is, for example, 0.1 to 10, is 0.2 to 7.5 in some embodiments, and may be 0.4 to 5.0. That is, the content of the crown ether compound with respect to 1 mole of the above-described metal ions is, for example, 0.1 moles to 10 moles, is 0.2 moles to 7.5 moles in some embodiments, and may be 0.4 moles to 5.0 moles. Similarly to the above, the inclusion compound is regarded as a mixture of both of them also in the relative ratio.

When the solid polymer electrolyte membrane contains the crown ether compound and the metal ions, the solid polymer electrolyte membrane that contains the crown ether compound and the metal ions can be obtained by, for example, the following methods.
(1) After a solid polymer electrolyte membrane is immersed in a solution containing metal ions to exchange ions of groups, such as a sulfonate group, with the metal ions, the solid polymer electrolyte membrane is immersed in a solution containing a crown ether compound so that the crown ether compound is included in the membrane.
(2) A method of producing a membrane by coating using a liquid obtained as follows. After a compound containing metal ions (such as cerium salt) is added in a dispersion liquid of polymer electrolytes to exchange ions of groups, such as a sulfonate group, with the metal ions, a solution or solid containing a crown ether compound is added to the dispersion liquid to obtain the liquid.
(3) A method in which a compound containing metal ions (such as cerium salt) and a crown ether compound are caused to react in a solvent to form an inclusion compound, and next, a solid polymer electrolyte membrane is immersed in a solution in which the inclusion compound is dissolved in the solvent to exchange ions of groups, such as a sulfonate group, with the inclusion compound so that the inclusion compound is included in the membrane.
(4) A compound containing metal ions (such as cerium salt) and a crown ether compound are caused to react in a solvent to form an inclusion compound. Next, the inclusion compound or its solution is added in a dispersion liquid of polymer electrolytes to obtain a liquid. A membrane is produced by coating using the obtained liquid.

### [Method for Producing Membrane Electrode Assembly]

A catalyst layer can be formed by, for example, a process of preparing a catalyst ink (for example, a solid content concentration of about 10%) including an electrode catalyst, an ionomer, and a solvent, a process of applying the catalyst ink over a substrate surface and volatilizing the solvent in the coating film to form a catalyst layer on the substrate surface, and a process of transferring the catalyst layer on the substrate surface to an electrolyte membrane. In addition, a catalyst layer can be formed by a method of directly applying the catalyst ink over a solid polymer electrolyte membrane instead of the substrate. By forming a cathode catalyst layer and an anode catalyst layer on the solid polymer electrolyte membrane, a membrane electrode assembly can be produced.

Examples of a method for applying the catalyst ink include, for example, a spray method, a blade coating method using a doctor blade or an applicator, a die coating method, a reverse roll coater method, and an intermittent die coating method.

For the anode catalyst layer, the above-described metal ions and the above-described crown ether compound may be contained in a catalyst ink for forming the anode catalyst layer. Specifically, the catalyst ink for forming the anode catalyst layer can include an electrode catalyst, an ionomer (for example, an ionomer having a sulfonate group), the above-described metal ions, the crown ether compound, and a solvent. The above-described metal ions and crown ether compound may be each added separately or may be added in a form of a complex of both.

### [Specific Configurations of Membrane Electrode Assembly and Solid Polymer Fuel Cell]

The basic unit of a solid polymer fuel cell is a membrane electrode assembly (MEA) in which catalyst layers (electrodes) are assembled to both surfaces of a solid polymer electrolyte membrane. In the solid polymer fuel cell, gas diffusion layers are generally disposed on external sides of the catalyst layers. The gas diffusion layers are for supplying a reaction gas and electrons to the catalyst layers, and carbon paper, carbon cloth, and the like are used. The catalyst layers are portions that become reaction fields of an electrode reaction.

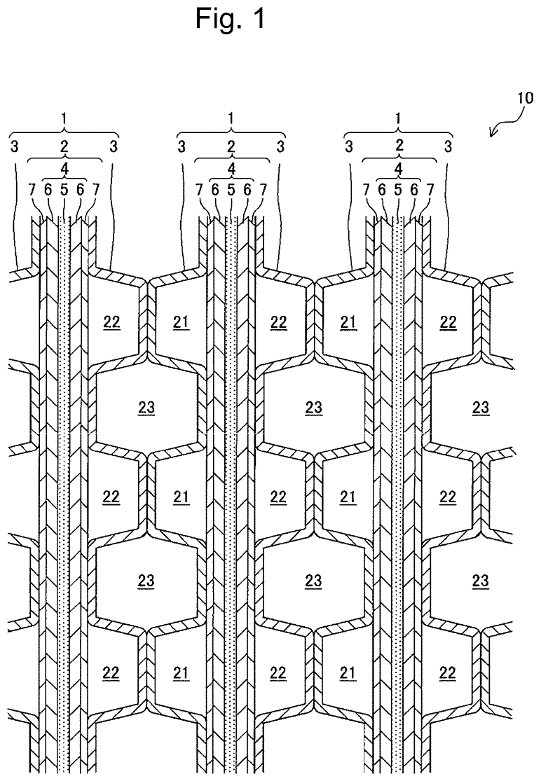

The following describes the configurations of the membrane electrode assembly and the solid polymer fuel cell with reference to FIG. 1. FIG. 1 is a schematic cross-sectional view for describing an exemplary configuration of the solid polymer fuel cell according to the embodiment and cross-sectional view of a main part of an exemplary fuel cell 10. The solid polymer fuel cell includes a stacked body of unit cells constituted of an electricity generating body and fuel cell separators disposed on both surfaces of the electricity generating body. The plurality of unit cells are stacked in a stacking direction, and the respective unit cells are electrically connected in series. As illustrated in FIG. 1, in the fuel cell 10, a plurality of unit cells 1 as a basic unit are stacked. Each unit cell 1 is a solid polymer fuel cell that generates an electromotive force by an electrochemical reaction between an oxidant gas (such as air) and a fuel gas (such as hydrogen). The unit cell 1 includes a membrane electrode gas diffusion layer assembly (MEGA) 2 and separators 3 in contact with the MEGA 2 so as to partition the MEGA 2. On both sides of the MEGA 2, gas diffusion layers (GDL) 7 are disposed. In the embodiment, the MEGA 2 are sandwiched by a pair of separators 3, 3.

The MEGA 2 includes a membrane electrode assembly (MEA) 4 and gas diffusion layers 7, 7 disposed on both surfaces of the membrane electrode assembly 4. The membrane electrode assembly 4 is constituted of an electrolyte membrane 5 and a pair of electrodes 6, 6 assembled to sandwich the electrolyte membrane 5. The electrolyte membrane 5 is, for example, a proton-conductive ion exchange membrane formed of a solid polymer material. The electrode 6 includes, for example, a porous carbon material supporting a catalyst, such as platinum. The electrode 6 disposed on one side of the electrolyte membrane 5 functions as an anode, and the electrode 6 on the other side functions as a cathode. The gas diffusion layer 7 is formed of a conductive member having gas permeability. Examples of the conductive member having gas permeability include, for example, a carbon porous body, such as carbon paper or carbon cloth, or a metal porous body, such as metal mesh or foam metal. In the embodiment, the anode electrode is constituted of an anode catalyst layer, and the cathode electrode is constituted of a cathode catalyst layer.

### EXAMPLES

The following describes the embodiment using examples.

### Production Example 1: Electrode Catalyst A

A platinum-supported catalyst was prepared, which contained Pt particles (average particle diameter: 3 nm to 4 nm) as a catalyst metal and carbon black (VULCAN, produced by Cabot Corporation, metal supported rate: 48 wt %) as a carrier on which metal particles were supported. The external-internal surface area ratio and the external-internal particle count ratio of the produced metal-supported carrier were calculated using the above-described methods and resulted in 2.25 and 1.14, respectively. As an analyzer, a transmission electron microscope (3D-TEM) was used, and specifically, the following method was employed. Using a TEM (JEM-z2500) manufactured by JEOL Ltd, a projected image (TEM image) of a sample was taken while inclining the sample continuously, and based on the projected image (TEM image), a three-dimensional image was reconstructed by computed tomography (CT) to analyze the detailed structures of materials.

### Production Example 2: Electrode Catalyst B

A platinum-supported catalyst was prepared, which contained Pt particles (average particle diameter: 2 nm to 3 nm) as a catalyst metal and carbon black (metal supported rate: 29 wt %) as a carrier on which metal particles were supported. The external-internal surface area ratio and the external-internal particle count ratio of the produced metal-supported carrier were calculated using the above-described methods and resulted in 1.15 and 0.67, respectively.

### Production Example 3: Electrode Catalyst C

A platinum-supported catalyst was prepared, which contained Pt particles (average particle diameter: 2 nm to 3 nm) as a catalyst metal and carbon black (metal supported rate: 48 wt %) as a carrier on which metal particles were supported. The external-internal surface area ratio and the external-internal particle count ratio of the produced metal-supported carrier were calculated using the above-described methods and resulted in 0.67 and 0.46, respectively.

### Production Example 4: Electrode Catalyst D

A platinum-supported catalyst was prepared, which contained Pt particles (average particle diameter: 2 nm to 3 nm) as a catalyst metal and carbon black (Ketjenblack EC300J, produced by Lion Specialty Chemicals Co., Ltd., metal supported rate: 42 wt %) as a carrier on which metal particles were supported. The external-internal surface area ratio and the external-internal particle count ratio of the produced metal-supported carrier were calculated using the above-described methods and resulted in 0.36 and 0.39, respectively.

### Example 1

### (Formation of Cathode Catalyst Layer)

The electrode catalyst B was dispersed in an ionomer solution (Nafion DE2020) including water and ethanol using a bead mill to prepare a catalyst ink. The water/alcohol mass ratio in the catalyst ink was about 1. The catalyst ink was coated over a polytetrafluoroethylene sheet and dried to form a cathode catalyst layer.

The Pt weight per unit area in the cathode catalyst layer was 0.2 mg/cm², and the mass ratio of ionomer to carbon carrier (I/C) was 1.0.

### (Formation of Complex (Ce-Ligand))

Benzo-18-crown-6-ether (also referred to as B18CRE) (3.12 g, 0.01 mol) and cerium nitrate (III) 6-hydrate (4.34 g, 0.01 mol) were weighed and taken into a 100 mL eggplant flask and stirred at room temperature for 24 hours with ethanol (20 mL) and water (20 mL) added. Then, after the solution was removed with an evaporator, vacuum drying was performed under 60° C. for one hour to obtain a white solid. By confirming that the peak derived from ether groups shifted to a low wavenumber side by FT-IR, it was confirmed that the crown ether compound included Ce.

### (Formation of Anode Catalyst Layer)

A platinum-supported carbon catalyst (TEC10E30E, 30% platinum-supported carbon, produced by Tanaka Precious Metal Technologies Co., Ltd.) was used as an electrode catalyst. The electrode catalyst and the above-described complex were dispersed in an ionomer solution (DE2020) including water, ethanol, and Nafion (registered trademark) to prepare a catalyst ink. The catalyst ink was coated over a polytetrafluoroethylene sheet and dried to form an anode catalyst layer.

The Pt weight per unit area in the anode catalyst layer was 0.1 mg/cm², and the cerium ion concentration was 6 μg/cm². A crown ether compound was added in a ratio of Ce:ligand=1:1 mol using the above-described method. The concentration of the crown ether compound was 13.5 μg/cm². The mass ratio of ionomer to carbon (I/C) was 1.0.

### (Production of Membrane Electrode Assembly)

The obtained cathode catalyst layer and anode catalyst layer were heat-transferred to both respective surfaces of a Nafion (registered trademark) membrane (NR211) to produce a membrane electrode assembly E1. The heat transfer conditions were set to 140° C., 50 kgf/cm² (4.90 MPa), and 5 min. The electrode area of the membrane electrode assembly for initial performance test was 1 cm×1 cm (1 cm²). The electrode area of the membrane electrode assembly for durability test was 3.6 cm×3.6 cm (12.96 cm²). The membrane electrode assembly was sandwiched by paper diffusion layers (GDL) with water-repellent layers to produce a test cell.

### Example 2

A membrane electrode assembly E2 was produced similarly to Example 1, except that the electrode catalyst C was used as an electrode catalyst in the cathode catalyst layer, and it was evaluated.

### Example 3

A membrane electrode assembly E3 was produced similarly to Example 1, except that the electrode catalyst D was used as an electrode catalyst in the cathode catalyst layer, and it was evaluated.

### Example 4

A membrane electrode assembly E4 was produced similarly to Example 3, except that the amount of B18CRE was doubled (6.24 g, 0.02 mol) when the complex was formed, and it was evaluated.

### Comparative Example 1

A membrane electrode assembly C1 was produced similarly to Example 1, except that the electrode catalyst A was used as an electrode catalyst in the cathode catalyst layer and that cerium nitrate (III) 6-hydrate was added instead of the complex to be added in the anode catalyst layer, and it was evaluated.

### Comparative Example 2

A membrane electrode assembly C2 was produced similarly to Example 1, except that the electrode catalyst A was used as an electrode catalyst in the cathode catalyst layer, and it was evaluated.

### Comparative Example 3

A membrane electrode assembly C3 was produced similarly to Example 1, except that cerium nitrate (III) 6-hydrate was added instead of the complex to be added in the anode catalyst layer, and it was evaluated.

### Comparative Example 4

A membrane electrode assembly C4 was produced similarly to Example 2, except that cerium nitrate (III) 6-hydrate was added instead of the complex to be added in the anode catalyst layer, and it was evaluated.

### Comparative Example 5

A membrane electrode assembly C5 was produced similarly to Example 3, except that cerium nitrate (III) 6-hydrate was added instead of the complex to be added in the anode catalyst layer, and it was evaluated.

[Evaluations] (Initial Performance Test)

The membrane electrode assembly for initial performance test (electrode area: 1 cm²) was used to perform cell evaluation. The current-voltage characteristics were evaluated under low humidification conditions (95° C., 30% RH) to measure the performance (voltage) at 1.5 A/cm². The sweep rate for evaluating the current-voltage characteristics was 20 mA/s, and the characteristics were obtained in the anodic sweep. In addition, the cell pressure was 150 kPa, the cathode gas type was air, and the cathode gas flow rate was 2.0 L/min. The results are shown in Table 1.

### (Durability Test: Voltage Decrease Rate)

The above-described test cells (electrode area: 12.96 cm²) were incorporated into a cell for power generation to conduct durability test under a low humidification environment (90° C., 40% RH). In the durability test, the initial characteristics of the solid polymer fuel cell and the characteristics after the durability test load were evaluated at a cell temperature of 90° C., with hydrogen/air supplied, and at a current density of 0.2 A/cm². Hydrogen and air were each supplied into a cell and humidified so as to have a dew point of 67° C. on the anode side and a dew point of 67° C. on the cathode side, and the cell voltage at the beginning of operation and the relationship between an elapsed time after starting the operation and the cell voltage were measured. The results are shown in Table 1. Under the above-described cell evaluation conditions, the cell voltage at the beginning of the operation and the cell voltage after a lapse of 300 hours after starting the operation were measured. The results are shown in Table 1.

TABLE 1

| | | Comparative | Comparative | Comparative | | Comparative |
|---|---|---|---|---|---|---|
| | Configuration | Example 1 | Example 2 | Example 3 | Example 1 | Example 4 |
| Anode Catalyst | Electrode Catalyst | TEC10E30E | TEC10E30E | TEC1DE30E | TEC10E30E | TEC10E30E |
| Layer | Cerium Nitrate | 6 μg/cm² | 6 μg/cm² | 6 μg/cm² | 6 μg/cm² | 6 μg/cm² |
| | Crown Ether | Not Added | B18CRE | Not Added | B18CRE | Not Added |
| | Compound | | (13.5 μg/cm²) | | (13.5 μg/cm²) | |
| Cathode Catalyst | Electrode Catalyst | Electrode | Electrode | Electrode | Electrode | Electrode |
| Layer | | Catalyst A | Catalyst A | Catalyst B | Catalyst B | Catalyst C |
| | External-Internal | 2.25 | 2.25 | 1.15 | 1.15 | 0.67 |
| | Surface Area Ratio | | | | | |
| | External-Internal | 1.14 | 1.14 | 0.67 | 0.67 | 0.46 |
| | Particle Count Ratio | | | | | |
| Initial Voltage | 95° C. 30% RH, | 468 | 433 | 418 | 407 | 595 |
| (mV) | 1.5 A/cm2 | | | | | |
| Initial Voltage | CRE Added - | — | −35 | — | −11 | — |
| Difference (mV) | CRE Not Added | | | | | |
| Voltage after | 95° C., 30% RH, | 405 | 414 | 364 | 398 | 522 |
| Durability | 1.5 A/cm2 | | | | | |
| Test (300 hours) | | | | | | |
| Voltage Retention | | 87% | 96% | 87% | 98% | 88% |
| Rate | | | | | | |

| | | | Comparative | | |
|---|---|---|---|---|---|
| | Configuration | Example 2 | Example 5 | Example 3 | Example 4 |
| Anode Catalyst | Electrode Catalyst | TEC10E30E | TEC10E30E | TEC10E30E | TEC10E30E |
| Layer | Cerium Nitrate | 6 μg/cm² | 6 μg/cm² | 6 μg/cm² | 9 μg/cm² |
| | Crown Ether | B18CRE | Not Added | B18CRE | B18CRE |
| | Compound | (13.5 μg/cm²) | | (13.5 μg/cm²) | (27 μg/cm²) |
| Cathode Catalyst | Electrode Catalyst | Electrode | Electrode | Electrode | Electrode |
| Layer | | Catalyst C | Catalyst D | Catalyst D | Catalyst C |
| | External-Internal | 0.67 | 0.36 | 0.36 | 0.36 |
| | Surface Area Ratio | | | | |
| | External-Internal | 0.46 | 0.39 | 0.39 | 0.39 |
| | Particle Count Ratio | | | | |
| Initial Voltage | 95° C. 30% RH, | 596 | 546 | 545 | 541 |
| (mV) | 1.5 A/cm2 | | | | |
| Initial Voltage | CRE Added - | 1 | — | −1 | −5 |
| Difference (mV) | CRE Not Added | | | | |
| Voltage after | 95° C., 30% RH, | 576 | 472 | 521 | 516 |
| Durability | 1.5 A/cm2 | | | | |
| Test (300 hours) | | | | | |
| Voltage Retention | | 97% | 86% | 96% | 95% |
| Rate | | | | | |

Upper limit values and/or lower limit values of respective numerical ranges described in the present specification can be appropriately combined to specify an appropriate range. For example, upper limit values and lower limit values of the numerical ranges can be appropriately combined to specify an appropriate range, upper limit values of the numerical ranges can be appropriately combined to specify an appropriate range, and lower limit values of the numerical ranges can be appropriately combined to specify an appropriate range.

While the embodiment has been described in detail, the specific configuration is not limited to the embodiment. Design changes within a scope not departing from the gist of the present disclosure are included in the present disclosure.

All publications, patents and patent applications cited in the present description are herein incorporated by reference as they are.

What is claimed is:

1. A membrane electrode assembly comprising:
a solid polymer electrolyte membrane;
an anode catalyst layer disposed on one surface of the solid polymer electrolyte membrane; and
a cathode catalyst layer disposed on the other surface of the solid polymer electrolyte membrane,
wherein the membrane electrode assembly comprises metal ions selected from cerium ions and manganese ions, and a crown ether compound capable of forming an inclusion compound with the metal ions or a salt thereof,
wherein the cathode catalyst layer comprises an electrode catalyst and an electrolyte,
wherein the electrode catalyst is a metal-supported carrier in which metal particles having catalytic activity are supported on a carrier having pores, and
wherein when metal particles present on outermost surfaces of primary particles of the carrier are external particles, and metal particles present inside the outermost surfaces of the primary particles of the carrier are internal particles,
a ratio of a total surface area of the external particles to a total surface area of the internal particles (total surface area of external particles/total surface area of internal particles) is 1.20 or less, and
a ratio of a total particle count of the external particles to a total particle count of the internal particles (total particle count of external particles/total particle count of internal particles) is 0.70 or less.

2. The membrane electrode assembly according to claim 1,
wherein a number of ring members of a ring structure of the crown ether compound is 15 or more.

3. The membrane electrode assembly according to claim 1,
wherein the crown ether compound has a molecular weight of 300 or more.

4. The membrane electrode assembly according to claim 1,
wherein the crown ether compound is at least one compound selected from the group consisting of dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, and dicyclohexano-24-crown-8-ether, and compounds in which an aromatic ring or an aliphatic ring of these compounds is substituted by at least one substituent selected from a halogen atom, a hydroxy group, an amino group, a nitro group, a formyl group, an alkyl group having 1 to 6 carbon atoms, a hydroxyalkyl group having 1 to 6 carbon atoms, a carboxyalkyl group having 2 to 7 carbon atoms, and an aryl group having 6 to 14 carbon atoms.

5. The membrane electrode assembly according to claim 1,
wherein for the metal particles, at least one kind is selected from the group consisting of platinum particles, platinum alloy particles, and composite particles containing platinum.
